(19) United States
(12) Patent Application Publication
(10) Pub. No.: US 2022/0115695 A1
(43) Pub. Date: Apr. 14, 2022

(54) ELECTROLYTE AND ELECTROCHEMICAL DEVICE COMPRISING THE SAME

(71) Applicant: Ningde Amperex Technology Limited, Ningde, Fujian (CN)

(72) Inventors: Chao Tang, Ningde, Fujian (CN); Junfei Liu, Ningde, Fujian (CN); Jianming Zheng, Ningde, Fujian (CN); Qian Wen, Ningde, Fujian (CN)

(21) Appl. No.: 17/281,547

(22) PCT Filed: Mar. 24, 2020
(86) PCT No.: PCT/CN2020/080914

§ 371 Date: Mar. 30, 2021

(51) Int. Cl. H01M 10/0567; H01M 10/0525; H01M 10/42

(52) U.S. Cl. CPC H01M 10/0567; H01M 10/4235; H01M 10/0525

(57) ABSTRACT

An electrolyte including a bis-cyclic sulfite compound and a multi-nitrile compound, which can form a stable protective layer on a positive electrode surface to ensure a lithium-ion battery stably operates at a voltage of ≥4.45V. The electrolyte can remarkably improve a high temperature intermittent cycle capacity retention ratio and a high temperature resistant safety performance upon circulation of the high-voltage lithium-ion battery.

### CROSS REFERENCE TO RELATED APPLICATIONS

The present application is a U.S. National Phase entry under 35 U.S.C. 371 of PCT international application: PCT/CN2020/080914, filed on 24 Mar. 2020, the disclosure of which is hereby incorporated by reference in its entirety.

### TECHNICAL FIELD

The application relates to the technical field of energy storage, in particular to an electrolyte and an electrochemical device comprising the same.

### BACKGROUND

The electrochemical device (e.g. a lithium-ion battery) is characterized by high energy density, high working voltage, low self-discharge rate, long cycle life, no pollution, or the like; and has been widely used as a power supply at present in cameras, phones, unmanned aerial vehicles, notebook computers, smart watches and other electronic products. In recent years, with the rapid development of intelligent electronic products, there is a higher requirement for the life of a lithium-ion battery. Increasing the charge cut-off voltage of the lithium-ion battery and the lithium removal of a positive electrode material is an effective means to improve the energy density of a lithium-ion battery. At present, 4.4V high-voltage lithium-ion battery products have been widely used. To further improve the charge cut-off voltage to 4.45V or even higher than 4.5V high-voltage system is the research hotspot of major scientific research institutions and battery manufacturers. However, increasing the charge cut-off voltage will also bring many problems, for example, the reaction activity between the positive electrode and the electrolyte under high voltage is enhanced, the battery is prone to expansion, and the cycling capacity fading is accelerated at high temperature. How to solve the problems of the lithium-ion batteries with high energy density and high voltage to improve the battery life has become an important topic in this field.

### SUMMARY

The invention provides an electrolyte and an electrochemical device comprising the same. The electrolyte contains a bis-cyclic sulfite compound and a multi-nitrile compound, which can form a stable protective layer on the surface of the positive electrode to ensure a lithium-ion battery stably operates at a voltage of ≥4.45V. The electrolyte can significantly improve the high temperature intermittent cycle capacity retention ratio and the high temperature resistant safety performance upon circulation of the high-voltage lithium-ion battery.

One aspect of the invention provides an electrolyte. In some embodiments, the electrolyte comprises:

a compound represented by Formula I; and
at least one compound represented by Formula II, Formula III, Formula IV or Formula V;
wherein, the compounds represented by Formula I, Formula II, Formula III, Formula IV and Formula V respectively are

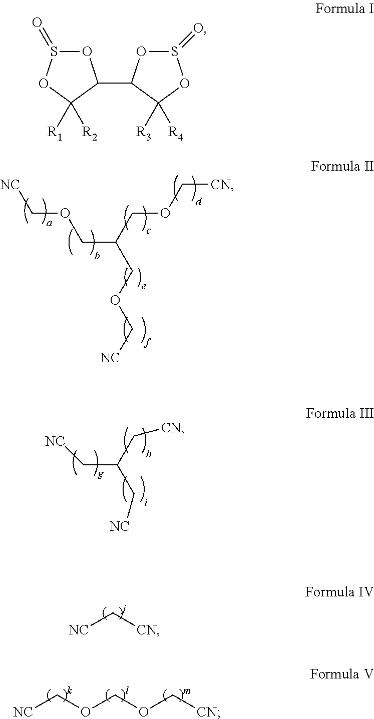

wherein, R₁, R₂, R₃ and R₄ are each independently selected from hydrogen, halogen, substituted or unsubstituted C₁-C₇ alkyl, wherein the substituted group is halogen or cyano group; a, d, f, h, j, k, l and m are each independently selected from the integers 1 to 5, and b, c, e, h, g and i are each independently selected from the integers 0 to 5.

In some embodiments, the compound represented by Formula I comprises at least one of the following compounds:

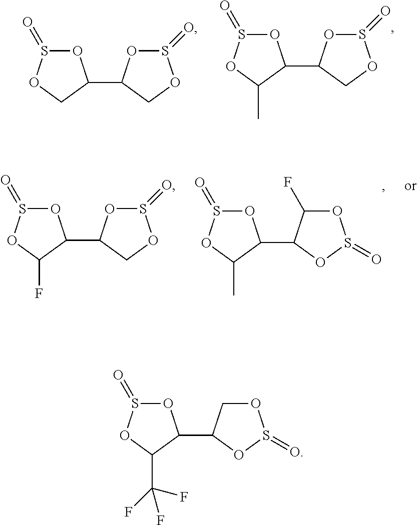

In some embodiments, the compound represented by Formula II comprises at least one of the following compounds:

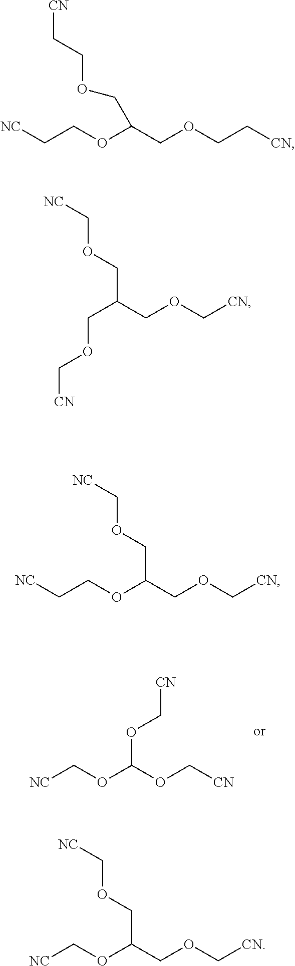 [SMILES: N#CCCOCC(COCCC#N)OCCC#N ; N#CCOCC(COCC#N)COCC#N ; N#CCCOC(COCC#N)COCC#N ; N#CCOC(OCC#N)OCC#N ; N#CCOCC(COCC#N)OCC#N]

In some embodiments, the compound represented by Formula III comprises at least one of the following compounds:

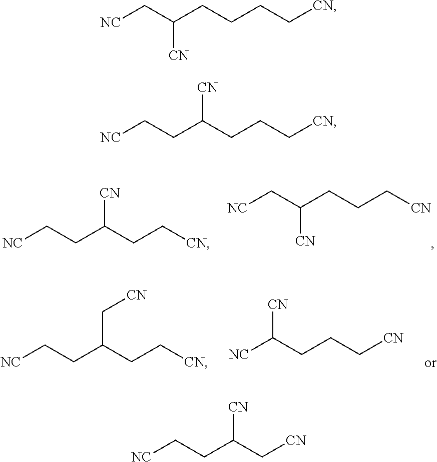

In some embodiments, the compound represented by Formula IV comprises at least one of the following compounds.

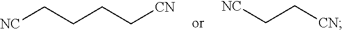 [SMILES: N#CCCCCC#N ; N#CCCC#N]

In some embodiments, the compound represented by Formula V comprises the following compound:

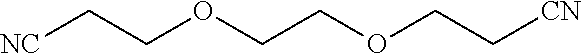 [SMILES: N#CCCOCCOCCC#N]

In some embodiments, an amount of the compound represented by Formula I accounts for 0.01% to 5% of the electrolyte by mass. In some embodiments, a total amount of the compound represented by Formula II, the compound represented by Formula III, the compound represented by Formula IV and the compound represented by Formula V accounts for 0.01% to 10% of the electrolyte by mass.

In some embodiments, an amount of the compound represented by Formula II accounts for 0.1% to 3% of the electrolyte by mass.

In some embodiments, an amount of the compound represented by Formula III accounts for 0.1% to 3% of the electrolyte by mass.

In some embodiments, an amount of the compound represented by Formula IV accounts for 0.1% to 7% of the electrolyte by mass.

In some embodiments, an amount of the compound represented by Formula V accounts for 0.1% to 3% of the electrolyte by mass.

Under high voltage, the bis-cyclic sulfite is oxidized on the surface of the positive electrode to form a macromolecular positive electrode protective layer, while the protective layer is not compact enough; at the same time, the multi-nitrile additives are easy to form coordination with the transition metal element on the positive electrode surface. Combined with the protective layer formed by the bis-cyclic sulfite, a dense protective layer can be formed on the positive electrode, which can significantly inhibit the expansion, capacity fading and thermal failure safety problems caused by side reaction of the electrolyte in the positive electrode at high temperature.

In some embodiments, the electrolyte further comprises a salt additive, and the salt additive comprises at least one of lithium difluoro(oxalato)borate, lithium bis(oxalato)borate, lithium tetrafluoroborate, lithium difluorophosphate, lithium tetrafluorophosphate, lithium tetrafluoro(oxalato)phosphate, lithium difluorobis(oxalato)phosphate, sodium bis(fluorosulfonyl)imide, sodium bis(trifluoromethanesulfonyl)imide, sodium hexafluorophosphate, potassium bis(fluorosulfonyl)imide, potassium bis(trifluoromethanesulfonyl)imide or potassium hexafluorophosphate; an amount of the salt additive accounts for 0.001% to 2% of the electrolyte by mass.

In some embodiments, the electrolyte further comprises an additive A, and the additive A comprises at least one of fluoroethylene carbonate, vinylene carbonate, or 1,3-propane sultone; an amount of the additive A accounts for 2% to 9% of the electrolyte by mass.

Another aspect of the invention provides an electrochemical device. The electrochemical device comprises a positive electrode, a negative electrode, a separator and any of the preceding electrolytes.

In some embodiments, the separator contains a polyolefin layer, and a protective layer which is provided on the polyolefin layer; the protective layer contains at least one of boehmite, Al2O3, ZnO, SiO2, TiO2 or ZrO2; the thickness of the protective layer is about 0.1 μm to 3 μm.

In some embodiments, the protective layer further contains a polymer, and the polymer comprises at least one of homopolymers and copolymers of tetrafluoroethylene, vinylidene fluoride, hexafluoroethylene, perfluoroalkyl vinyl ether, ethylene, trifluorochloroethylene, propylene, acrylic acid, methacrylic acid, itaconic acid, ethyl acrylate, butyl acrylate, acrylonitrile, methacrylonitrile; the ratio of the thickness of the polyolefin layer to the thickness of the protective layer is about 1:1 to about 20:1.

In some embodiments, the negative electrode contains a negative electrode active material, and the negative electrode active material contains a silicon-containing material and graphite; the weight ratio of the silicon-containing material to the graphite is 5:95 to 50:50.

The further aspect of the invention provides an electronic device, and the electronic device comprises any of the preceding electrochemical devices.

The additional aspects and advantages of the embodiments of the application will be described, shown, or explained in part by the implementation of the embodiments of the application.

### DETAILED DESCRIPTION

The embodiments of the application will be described in detail below. The embodiments of the application shall not be interpreted to limit the scope of protection required by the application. The following terms as used herein have the meanings set forth below, unless otherwise expressly indicated.

As used herein, the term “about” is used to describe and illustrate small changes. When used in conjunction with an event or circumstance, the term may refer to an example in which the event or circumstance occurs precisely and an example in which the event or circumstance occurs very closely. For example, when used in conjunction with a value, the term may refer to a range of variation less than or equal to ±10% of the value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. Moreover, the amount, ratio, and other values are sometimes presented in range format herein. It should be understood that such range format is for convenience and conciseness, and it should be understood flexibly to include not only the value explicitly designated as the limit of the range, but also all individual values or sub-ranges covered by the range as if each value and sub-range are explicitly specified.

In specific implementations and claims, the list of items connected by the term “one of” may mean any of the listed items. For example, if items A and B are listed, the phrase “one of A and B” means only A or only B. In another example, if items A, B, and C are listed, the phrase “one of A, B, and C” means only A; only B; or only C. The item A may contain single element or multiple elements. The item B may contain single element or multiple elements. The item C may contain single element or multiple elements.

In specific embodiments and claims, the list of items connected by the term “at least one of” may mean any combination of the listed items. For example, if items A and B are listed, the phrase “at least one of A and B” or “at least one of A or B” means only A; only B; or A and B. In another example, if items A, B and C are listed, the phrase “at least one of A, B and C” or “at least one of A, B or C” means only A; or only B; only C; A and B (excluding C); A and C (excluding B); B and C (excluding A); or all of A, B and C. The item A may contain single element or multiple elements. The item B may contain single element or multiple elements. The item C may contain single element or multiple elements.

In the implementations and claims, for the expression about the carbon number, i.e., the figure behind the capital letter “C”, such as “C1-C10”, “C3-C10”, the figure behind “C”, such as “1”, “3” or “10”, indicates the carbon number in the specific functional group. That is, the functional group may include 1-10 carbon atoms and 3-10 carbon atoms respectively. For example, “C1-C4 alkyl” refers to an alkyl with 1-4 carbon atoms, such as CH3-, CH3CH2-, CH3CH2CH2-, (CH3)2CH—, CH3CH2CH2CH2-, CH3CH2CH(CH3)- or (CH3)3C—.

As used herein, the term “alkyl” is expected to be a straight-chain saturated hydrocarbon structure with 1-7 carbon atoms. The “alkyl” is also expected to be a branched chain or cyclic hydrocarbon structure with 3-7 carbon atoms. For example, the alkyl may be the alkyl with 1-7 carbon atoms, or the alkyl with 1-4 carbon atoms. When an alkyl with a specific carbon number is specified, it is expected to cover all geometric isomers with that carbon number; therefore, for example, “butyl” means n-butyl, sec-butyl, isobutyl, tert-butyl and cyclobutyl; “propyl” includes n-propyl, isopropyl and cyclopropyl. The alkyl examples include, but are not limited to methyl, ethyl, n-propyl, isopropyl, cyclopropyl, n-butyl, isobutyl, sec-butyl, tert-butyl, cyclobutyl, n-amyl, isoamyl, neopentyl, cyclopentyl, methylcyclopentyl, ethyl cyclopentyl, n-hexyl, isohexyl, cyclohexyl, n-heptyl, octyl, cyclopropyl, cyclobutyl, norbornyl, etc. Moreover, the alkyl may be optionally substituted.

As used herein, the term “halogen” covers F, Cl, Br, and I, preferably F or Cl.

When the substituent is substituted, the substituent may be substituted by one or more substituents selected from halogen or cyano group.

As used herein, the content of each constituent in the electrolyte is obtained based on the total weight of the electrolyte.

### I. Electrolyte

Some embodiments of the invention provide an electrolyte, and the electrolyte comprises:

a compound represented by Formula I; and
at least one compound represented by Formula II, Formula III, Formula IV or Formula V;
wherein, the compounds represented by Formula I, Formula II, Formula III, Formula IV and Formula V respectively are

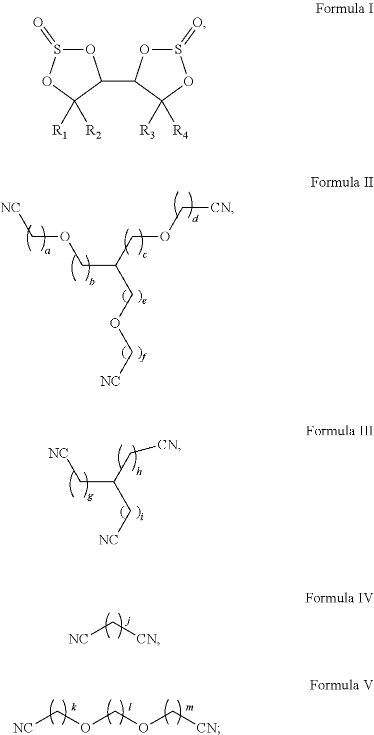

where, R₁, R₂, R₃ and R₄ are each independently selected from hydrogen, halogen, substituted or unsubstituted C₁-C₇ alkyl, wherein the substituted group is halogen or cyano group; a, d, f, h, j, k, l and m are each independently selected from 1, 2, 3, 4 or 5; b, c, e, h, g and i are each independently selected from 0, 1, 2, 3, 4 or 5.

In some embodiments, R₁, R₂, R₃ and R₄ are each independently selected from hydrogen, halogen, substituted or unsubstituted C₁-C₅ alkyl, wherein the substituted group is halogen or cyano group; a, d, f, h, j, k, l and m are each independently selected from 1, 2, 3 or 4; b, c, e, h, g and i are each independently selected from 0, 1, 2, 3 or 4.

In some embodiments, R₁, R₂, R₃ and R₄ are each independently selected from hydrogen, fluorine, fluoro-substituted or unsubstituted C₁-C₅ alkyl; a, d, f, h, j, k, l and m are each independently selected from 1, 2 or 3; b, c, e, h, g and i are each independently selected from 0, 1, 2 or 3.

In some embodiments, R₁, R₂, R₃ and R₄ are each independently selected from hydrogen, fluorine, methyl, ethyl, or —CF₃.

In some embodiments, the compound represented by Formula I comprises at least one of the following compounds:

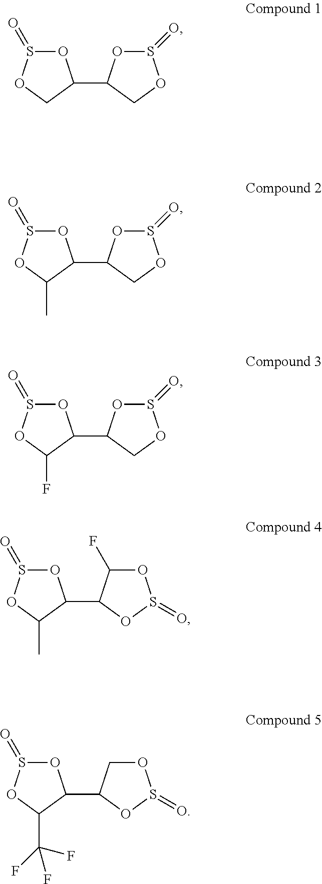 [SMILES: O=S1OCC(C2COS(=O)O2)O1 ; CC1OS(=O)OC1C1COS(=O)O1 ; O=S1OCC(C2OS(=O)OC2F)O1 ; CC1OS(=O)OC1C1OS(=O)OC1F ; O=S1OCC(C2OS(=O)OC2C(F)(F)F)O1]

In some embodiments, the compound represented by Formula II comprises at least one of the following compounds:

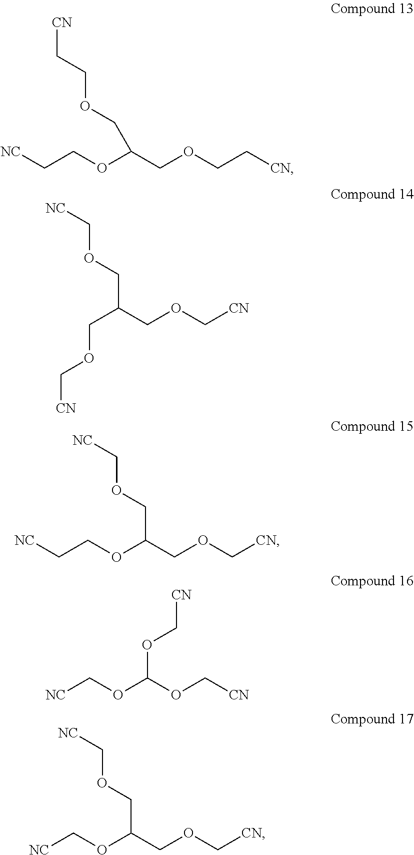

In some embodiments, the compound represented by Formula III comprises at least one of the following compounds:

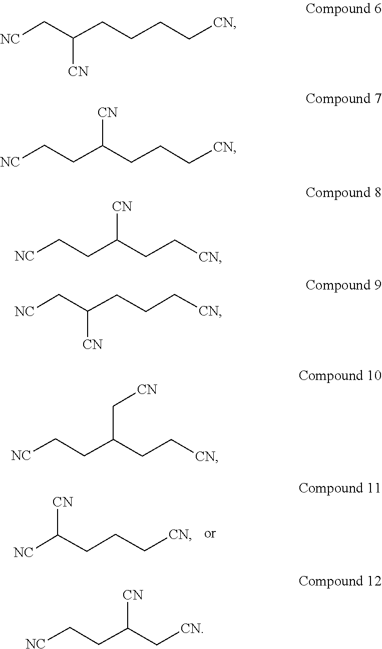

In some embodiments, the compound represented by Formula IV comprises at least one of the following compounds:

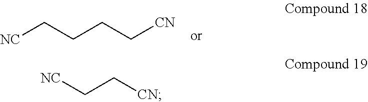

In some embodiments, the compound represented by Formula V comprises the following compound:

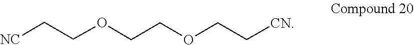 [SMILES: N#CCCOCCOCCC#N]

In some embodiments, an amount of the compound represented by Formula I accounts for 0.01% to 5%, 0.1% to 4%, 0.1% to 3%, or 0.2% to 1% of the electrolyte by mass. In some embodiments, an amount of the compound represented by Formula I accounts for about 0.05%, about 0.3%, about 0.4%, about 0.5%, about 0.6%, about 0.7%, about 0.8%, about 0.9%, about 1.0%, about 1.2%, about 1.4%, about 1.6%, about 1.8%, about 2.0%, about 2.5%, about 3.5%, or about 4.5% of the weight of the electrolyte.

In some embodiments, an amount of the compound represented by Formula II accounts for 0.1% to 3%, 0.1% to 2%, 0.3% to 2%, or 0.5% to 2% of the electrolyte by mass.

In some embodiments, an amount of the compound represented by Formula III accounts for 0.1% to 3%, 0.1% to 2%, 0.3% to 2%, or 0.5% to 2% of the electrolyte by mass.

In some embodiments, an amount of the compound represented by Formula IV accounts for 0.1% to 7%, 0.1% to 6%, 0.1% to 5%, 0.3% to 6%, 0.5% to 6%, or 1% to 5% of the electrolyte by mass.

In some embodiments, an amount of the compound represented by Formula V accounts for 0.1% to 3%, 0.1% to 2%, 0.3% to 2%, or 0.5% to 2% of the electrolyte by mass.

In some embodiments, a total amount of the compound represented by Formula II, the compound represented by Formula III, the compound represented by Formula IV and the compound represented by Formula V accounts for 0.1% to 10%, 0.2% to 9%, 0.3% to 8%, 0.4% to 7%, 0.5% to 6%, 0.6% to 5%, or 0.7% to 4% of the electrolyte by mass. In some embodiments, a total amount of the compound represented by Formula II, the compound represented by Formula III, the compound represented by Formula IV and the compound represented by Formula V accounts for about 1%, about 1.5%, about 2%, about 2.5%, about 3%, about 3.5%, about 4%, about 4.5%, about 5.5%, about 6.5%, about 7.5%, about 8.5%, or about 9.5% of the electrolyte by mass.

In some embodiments, to further improve the secondary battery, it is also necessary to strengthen the stability of the electrolyte. The electrolyte further contains a salt additive. The combined action of at least one of the compound represented by Formula II, the compound represented by Formula III, the compound represented by Formula IV or the compound represented by Formula V, the salt additive and the compound represented by Formula I can improve the stability of the electrolyte, inhibit the production of acidic substances in the electrolyte, reduce the etching action of the protective layer on the positive electrode surface, consequently to improve the stability of the protective layer formed by bisulfate and multi-nitrile additives on the positive electrode, and keep the positive electrode interface stable for a long time under high voltage. The salt additive contains at least one of lithium difluoro(oxalato)borate (LiDFOB), lithium bis(oxalato)borate (LiBOB), lithium tetrafluoroborate (LiBF4), lithium difluorophosphate (LiPO2F2), lithium tetrafluorophosphate (LiPOF4), lithium tetrafluoro(oxalato)phosphate, lithium difluorobis(oxalato)phosphate, sodium bis(fluorosulfonyl)imide (NaF SI), sodium bis(trifluoromethanesulfonyl)imide (NaTFSI), sodium hexafluorophosphate (NaPF6), potassium bis(fluorosulfonyl)imide (KFSI), potassium bis(trifluoromethanesulfonyl)imide (KTFSI) or potassium hexafluorophosphate (KPF6);

In some embodiments, an amount of the salt additive accounts for 0.001% to 2%, 0.01% to 1.8%, 0.05% to 1.6% of the electrolyte by mass. In some embodiments, an amount of the salt additive accounts for about 0.1%, about 0.2%, about 0.3%, about 0.4%, about 0.5%, about 0.6%, about 0.7%, about 0.8%, about 0.9%, about 1.0%, about 1.2%, or about 1.4% of the electrolyte by mass.

In some embodiments, to further improve the cycling stability of the high energy density secondary battery, the electrolyte further contains an additive A, and the additive A contains at least one of fluoroethylene carbonate (FEC), vinylene carbonate (VC), or 1,3-propane sultone (PS).

In some embodiments, an amount of the additive A accounts for 2% to 9% of the electrolyte by mass. In some embodiments, an amount of the salt additive accounts for about 2.5%, about 3%, about 3.5%, about 4%, about 4.5%, about 5%, about 5.5%, about 6%, about 6.5%, about 7%, about 7.5%, about 8%, or about 8.5% of the electrolyte by mass.

In some embodiments, the electrolyte further contains a lithium salt and an organic solvent.

In some embodiments, the lithium salt is selected from one or more of inorganic lithium salts and organic lithium salts. In some embodiments, the lithium salt contains at least one of fluorine, boron or phosphorus. In some embodiments, the lithium salt is selected from one or more of the following lithium salts: lithium hexafluorophosphate (LiPF6), lithium bis(trifluoromethanesulfonyl)imide (LiTFSI), lithium bis(fluorosulfonyl)imide (LiFSI), lithium hexafluoroarsenate (LiAsF6), lithium perchlorate (LiClO4), or lithium trifluoromethanesulfonate (LiCF3SO3).

In some embodiments, the concentration of the lithium salt is 0.5 mol/L to 1.5 mol/L. In some embodiments, the concentration of the lithium salt is 0.8 mol/L to 1.2 mol/L. In some embodiments, the concentration of the lithium salt is 0.9 mol/L to 1.1 mol/L.

The solvent contains a cyclic ester and a chain ester, wherein the cyclic ester is selected from at least one of ethylene carbonate (EC), propylene carbonate (PC), γ-butyrolactone (BL) and butylene carbonate; the chain ester is selected from at least one of dimethyl carbonate (DMC), diethyl carbonate (DEC), ethyl methyl carbonate (EMC), ethyl propyl carbonate, methyl formate (MF), ethyl formate (MA), ethyl acetate (EA), ethyl propionate (EP), propyl propionate (PP), methyl propionate, methyl butyrate, ethyl butyrate, methyl ethyl fluorocarbonate, dimethyl fluorocarbonate, diethyl fluorocarbonate, ethyl fluoropropionate, propyl fluoropropionate, methyl fluoropropionate, ethyl fluoroacetate, methyl fluoroacetate and propyl fluoroacetate.

In some embodiments, the solvent accounts for about 70% to about 95% of the weight of the electrolyte.

### II. Electrochemical Device

The electrochemical device of the application includes any device that generates electrochemical reaction, and specific examples include all kinds of primary batteries, secondary batteries, fuel batteries, solar batteries or capacitors. Particularly, the electrochemical device is a lithium secondary battery, including a lithium metal secondary battery, a lithium ion secondary battery, a lithium polymer secondary battery or a lithium ion polymer secondary battery. In some embodiments, the electrochemical device of the application is an electrochemical device having a positive electrode with a positive electrode active material capable of absorbing and releasing metal ions and a negative electrode with a negative active material capable of absorbing and releasing metal ions, wherein any of the preceding electrolytes of the application is included.

### Electrolyte

The electrolyte used in the electrochemical device of the application is any of the preceding electrolytes in the application. Moreover, the electrolyte used in the electrochemical device of the application may further contain other electrolytes not departing from the subject matter of the application.

### Negative Electrode

The material, composition and manufacturing method of the negative electrode used in the electrochemical device of the application may include any technology disclosed in the prior art. In some embodiments, the negative electrode is the one recorded in US patent application U.S. Pat. No. 9,812,739B, which is incorporated in the application by full-text reference.

In some embodiments, the negative electrode includes a current collector and a negative electrode active material layer located on the current collector. The negative electrode active material includes a material that can be reversibly embedded/disembedded with lithium ions. In some embodiments, the material that can be reversibly embedded/disembedded with lithium ions includes a carbon material. In some embodiments, the carbon material may be any carbon-based negative electrode active material commonly used in lithium-ion rechargeable batteries. In some embodiments, the carbon material includes, but is not limited to: crystalline carbon, amorphous carbon, or a mixture thereof. The crystalline carbon may be amorphous, flaky, small flaky, spherical or fibrous natural graphite or artificial graphite. The amorphous carbon may be soft carbon, hard carbon, mesophase pitch carbide, calcined coke, etc.

In some embodiments, the negative electrode active material layer includes a negative electrode active material. In some embodiments, the negative electrode active material includes, but is not limited to: lithium metal, structured lithium metal, natural graphite, artificial graphite, mesocarbon microbead (MCMB), hard carbon, soft carbon, silicon, silicon-carbon composite, Li—Sn alloy, Li—Sn—O alloy, Sn, SnO, SnO2, spinel structured lithium-TiO2-Li4Ti5O12, Li—Al alloy or any combination thereof. In some embodiments, the negative electrode active material includes a silicon-containing material, and the silicon-containing material contains SiOx, a monatomic silicon or a mixture thereof, where 0.5<x<1.5.

When the negative electrode comprises carbon and silicon materials, the ratio of carbon to silicon materials is about 95:5 to about 50:50, about 90:10 to about 60:40, about 85:15 to about 70:30, and about 80:20 to about 75:25 based on the total weight of the negative electrode active material. When the negative electrode includes alloy materials, and the negative electrode active material layer can be formed by vapor deposition, sputtering, plating and other methods. When the negative electrode includes lithium metal, for example, the negative electrode active material layer is formed by using a conductive skeleton with spherical stranded shape and metal particles dispersed in the conductive skeleton. In some embodiments, the spherical stranded conductive skeleton may have a porosity of about 5% to about 85%. In some embodiments, a protective layer can also be provided on the lithium metal negative electrode active material layer.

In some embodiments, the negative electrode active material layer may contain a binder, and optionally contain a conductive material. The binder improves the binding between the negative electrode active material particles and the binding between the negative electrode active material and the current collector. In some embodiments, the binder includes, but is not limited to: polyvinyl alcohol, carboxymethyl cellulose, hydroxypropyl cellulose, diacetyl cellulose, polyvinyl chloride, carboxylated polyvinyl chloride, polyfluoroethylene, polymer containing ethyleneoxy, polyvinylpyrrolidone, polyurethane, teflon, polyvinylidene 1,1-difluoride, polyethylene, polypropylene, styrene butadiene rubber, acrylic acid (ester) modified styrene butadiene rubber, epoxy resin, nylon, etc.

In some embodiments, the conductive material includes, but is not limited to: a carbon-based material, a metal-based material, a conductive polymer or a mixture thereof. In some embodiments, the carbon-based material is selected from natural graphite, artificial graphite, carbon black, acetylene black, Ketjen black, carbon fiber or any combination thereof. In some embodiments, the metal-based material is selected from metal powder, metal fiber, copper, nickel, aluminum and silver. In some embodiments, the conductive polymer is a polyphenylene derivative.

In some embodiments, the current collector includes, but is not limited to: copper foil, nickel foil, stainless steel foil, titanium foil, nickel foam, copper foam, polymer substrate covered with conductive metal and any combination thereof.

The negative electrode may be prepared by a preparation method well known in the art. For example, the negative electrode may be obtained through the following methods: mixing the active material, conductive material and the binder in the solvent to prepare an active material composition, and coating the active material composition on the current collector. In some embodiments, the solvent may include water, etc., but is not limited to this.

### Positive Electrode

The material of the positive electrode used in the electrochemical device of the application may be prepared by using the material, structure and manufacturing method well known in the art. In some embodiments, the positive electrode of the application can be prepared by using the technology recorded in U.S. Pat. No. 9,812,739B, which is incorporated in the application by full-text reference.

In some embodiments, the positive electrode includes a current collector and a positive electrode active material layer located on the current collector. The positive electrode active material includes at least one lithium intercalation compound that is reversibly embedded and disembedded with lithium ions. In some embodiments, the positive electrode active material includes a composite oxide. In some embodiments, the composite oxide contains lithium and at least one element selected from cobalt, manganese and nickel.

In some embodiments, the positive electrode active material is selected from lithium cobaltate (LiCoO2), LiNiCoMn (NCM) ternary material, lithium iron phosphate (LiFePO4), lithium manganate (LiMn2O4) or any combination thereof.

In some embodiments, the positive electrode active material may have a coating on the surface, or may be mixed with another compound having a coating. The coating may include at least one coating element compound selected from the oxide, hydroxide, oxyhydroxide, oxycarbonate and the hydroxyl carbonate of the coating element. The compound used for coating may be amorphous or crystalline.

In some embodiments, the coating elements contained in the coating may include Mg, Al, Co, K, Na, Ca, Si, Ti, V, Sn, Ge, Ga, B, As, Zr or any combination thereof. The coating can be applied by any method as long as the method does not adversely affect the performance of the positive electrode active material. For example, the method may include any coating method well known in the art, such as spraying, dipping.

The positive electrode active material layer further contains a binder, and optionally contains a conductive material. The binder improves the binding between the positive electrode active material particles, and also the binding between the positive electrode active material and the current collector.

In some embodiments, the binder includes, but is not limited to: polyvinyl alcohol, hydroxypropyl cellulose, diacetyl cellulose, polyvinyl chloride, carboxylated polyvinyl chloride, polyfluoroethylene, polymer containing ethyleneoxy, polyvinylpyrrolidone, polyurethane, teflon, polyvinylidene 1,1-difluoride, polyethylene, polypropylene, styrene butadiene rubber, acrylic acid (ester) modified styrene butadiene rubber, epoxy resin, nylon, etc.

In some embodiments, the conductive material includes, but is not limited to: a carbon-based material, a metal-based material, a conductive polymer and a mixture thereof. In some embodiments, the carbon-based material is selected from natural graphite, artificial graphite, carbon black, acetylene black, Ketjen black, carbon fiber or any combination thereof. In some embodiments, the metal-based material is selected from metal powder, metal fiber, copper, nickel, aluminum and silver. In some embodiments, the conductive polymer is a polyphenylene derivative.

In some embodiments, the current collector may be aluminum, but is not limited to this.

The positive electrode may be prepared by a preparation method well known in the art. For example, the positive electrode may be obtained through the following methods: mixing the active material, conductive material and the binder in the solvent to prepare an active material composition, and coating the active material composition on the current collector. In some embodiments, the solvent may include N-methyl pyrrolidone, etc., but is not limited to this.

In some embodiments, the positive electrode is made by using a positive electrode active material layer including lithium transition metal compound powder and a binder to form a positive electrode material on the current collector.

In some embodiments, the positive electrode active material layer can be made by the following operation: dry mixing the positive electrode material and the binder (conductive material and thickener, etc., as required) to form a sheet, pressing the obtained sheet to the positive current collector, or dissolving or dispersing these materials in the liquid medium to form a slurry, then coating on the positive current collector and drying. In some embodiments, the material of the positive electrode active material layer includes any material well known in the art.

### Separator

In some embodiments, the electrochemical device of the application is provided with a separator between the positive electrode and the negative electrode to prevent short circuit. The material and shape of the separator used in the electrochemical device of the application are not particularly restricted, and can be disclosed in any prior art. In some embodiments, the separator includes a polymer or an inorganic matter formed from a material stable to the electrolyte of the application.

For example, the separator may include a substrate layer and a coating. The substrate layer is a non-woven fabric, membrane or composite membrane with a porous structure, and the material of the substrate layer is selected from at least one of polyethylene, polypropylene, polyethylene terephthalate and polyimide. Specifically, a porous polypropylene membrane, a porous polyethylene membrane, polypropylene non-woven fabric, polyethylene non-woven fabric or a porous polypropylene-polyethylene-polypropylene composite membrane can be selected. The substrate layer can be one layer or multi-layer. When the substrate layer is multi-layer, the polymer composition of different substrate layers can be the same or different, and the weight-average molecular weight is different; when the substrate layer is multi-layer, the polymer shutdown temperatures of different substrate layers are different.

In some embodiments, at least one surface of the substrate layer of the application is provided with a coating, which can be a polymer layer or an inorganic layer, or a layer formed by a mixture of a polymer and an inorganic matter. The thickness of the coating ranges from 0.1 μm to 4 μm, 0.4 μm to 3.5 μm, 0.8 μm to 3 μm, or 1.2 μm to 3 μm.

In some embodiments, the separator contains a polyolefin layer, and a protective layer which is provided on the polyolefin layer. These protective layers may avoid the direct contact between the polymer separating membrane and the positive electrode, and prevent the oxidation damage of the high voltage positive electrode to the polymer separating membrane. The protective layer contains at least one of boehmite, Al2O3, ZnO, SiO2, TiO2 or ZrO2; the thickness of the protective layer is about 0.1 μm to 3 μm.

In some embodiments, the protective layer further contains a polymer, and the polymer comprises at least one of homopolymers and copolymers of tetrafluoroethylene, vinylidene fluoride, hexafluoropropylene, perfluoroalkyl vinyl ether, ethylene, trifluorochloroethylene, propylene, acrylic acid, methacrylic acid, itaconic acid, ethyl acrylate, butyl acrylate, acrylonitrile, methacrylonitrile.

In some embodiments, the ratio of the thickness of the polyolefin layer to the thickness of the protective layer is 1:1 to 20:1, and in some embodiments, the ratio of the thickness of the polyolefin layer to the thickness of the protective layer is about 2:1, about 3:1, about 4:1, about 5:1, about 6:1, about 7:1, about 8:1, about 9:1, about 10:1, about 12:1, about 14:1, about 16:1, or about 18:1.

In some embodiments, the separator contains a porous polyethylene separating membrane with a thickness of about 7 μm. One side of the separating membrane is coated with a coating about 1.5 μm thick, and the coating contains Al2O3 and polyvinylidene fluoride (PVDF).

### III. Application

The electrolyte according to the embodiments of the application can form a stable protective layer on the surface of the positive and negative electrode materials, so as to ensure the stable charge and discharge of the lithium-ion battery at a high voltage of ≥4.45V, and it is suitable for use in electronic equipment including an electrochemical device.

The purpose of the electrochemical device of the application is not specially restricted, and can be used for various well-known purposes, such as notebook computers, pen-type computers, mobile computers, e-book players, portable phones, portable fax machines, portable copiers, portable printers, head mounted stereo headsets, video recorders, liquid crystal TVs, portable cleaners, portable CD players, mini disks, transceivers, electronic notebooks, calculators, memory cards, portable recorders, radios, standby power supplies, motors, automobiles, motorcycles, power-assisted bicycles, bicycles, lighting appliances, toys, game machines, clocks, electric tools, flashlights, cameras, large household batteries or lithium-ion capacitors.

### IV. Embodiment

In the following, embodiments and Comparative Examples are cited to further describe the application, however, the application is not limited to these embodiments as long as they do not deviate from the subject matter.

### 1. Preparation of a Lithium-Ion Battery

### (1) Preparation of a Negative Electrode

The negative electrode active material graphite, binder styrene butadiene rubber (SBR) and the thickener sodium carboxymethyl cellulose (CMC) are dispersed according to a weight ratio of 97:2:1 in the appropriate amount of water, fully stirred and mixed evenly; the negative electrode slurry is coated on 8 μm negative electrode current collector copper foil, then baked for 1 h at 120° C. to form a negative electrode active material layer, and the negative electrode is obtained through compaction, slitting and welding a tab.

### (2) Preparation of a Positive Electrode

The positive electrode active material lithium cobaltate (LiCoO₂), conductive carbon and the binder polyvinylidene fluoride (PVDF) are dispersed according to a weight ratio of 97:1.5:1.5 in the appropriate amount of N-methyl pyrrolidone (NMP), fully stirred and mixed evenly; the positive electrode slurry is coated on 10 μm positive electrode current collector aluminum foil, then baked for 1 h at 120° C. to form a positive electrode active material layer, and the positive electrode is obtained through compaction, slitting and welding a tab.

### (3) Preparation of an Electrolyte

In a dry argon atmosphere glove box, ethylene carbonate (EC), propylene carbonate (PC), diethyl carbonate (DEC) and ethyl propionate (EP) are mixed according to a mass ratio of 30:10:30:30, and LiPF₆ is added as a lithium salt. The electrolyte is prepared by adding certain types and amounts of substances (the types and amounts of added substances are shown in Table 1, and the content of each substance is calculated based on the total weight of the electrolyte) after mixing evenly. The concentration of LiPF₆ in the electrolyte is 1.05 mol/L.

### (4) Preparation of a Separator

7 μm thick porous polyethylene separating membrane is selected, and 1.5 μm thick coating is applied on one side of the separating membrane. The coating contains Al₂O₃ and polyvinylidene fluoride (PVDF).

### (5) Preparation of a Lithium-Ion Battery

The positive electrode, separator and negative electrode are stacked in order to make the separator in the middle of the positive and negative electrodes, then wound and placed in the aluminum foil packaging bag, baked and dewatered at 80° C., injected with electrolyte, sealed, formed, vented and capacity-tested to obtain the finished lithium-ion secondary battery. The size of the obtained lithium-ion battery is 3.3 mm×39 mm×96 mm.

### Embodiments 1˜24 and Comparative Examples 1˜2

The electrolyte and lithium-ion battery in Embodiments 1˜24 and Comparative Examples 1-2 are prepared according to the preceding methods (1)˜(5).

### Embodiment 25 and Comparative Examples 3˜4

For the preparation of the electrolyte and lithium-ion battery in Embodiment 25 and Comparative Examples 3˜4, the negative electrode is prepared according to the following method, and others are prepared according to the preceding methods (2)˜(5).

The negative electrode active material graphite, negative electrode active material silicon oxide (SiOx, 0.5<x<1.5), binder styrene butadiene rubber (SBR) and the thickener sodium carboxymethyl cellulose (CMC) are dispersed according to a weight ratio of 87:10:2:1 in the appropriate amount of water, fully stirred and mixed evenly; the negative electrode slurry is coated on 8 μm negative electrode current collector copper foil, then baked for 1 h at 120° C., and the negative electrode is obtained through compaction, slitting and welding a tab.

### Embodiments 26˜27

The separator in embodiments 26˜27 is prepared according to the following method, and others are prepared according to the preceding methods (1)˜(3) and (5):

7 μm thick porous polyethylene separating membrane is selected, and 1.5 μm thick coating is applied on one side of the separating membrane. The coating contains boehmite and polyvinylidene fluoride (PVDF).

### Embodiments 28˜29

The separator in embodiments 28˜29 is prepared according to the following method, and others are prepared according to the preceding methods (1)˜(3) and (5):

7 μm thick porous polyethylene separating membrane is selected, and 1.0 μm thick coating is applied on one side of the separating membrane. The coating contains boehmite and polyvinylidene fluoride-hexafluoropropylene copolymer (PVDF-HFP).

TABLE 1
Embodiments and Comparative Examples

| | Content of electrolyte additive, % | | | | | | | | | | | | |
|---|---|---|---|---|---|---|---|---|---|---|---|---|---|
| | | | | Com- | Com- | Com- | Com- | | | | | | |
| | | | | pound | pound | pound | pound | | | | | | |
| | | | | in | in | in | in | | | | | | |
| | | | | Form | Form | form | form | | | | | | |
| | Compound in | | | Formula | Formula | formula | formula | | | | | | |
| | Formula I | | | III | II | IV | V | | | | | | Negative |
| | Com- | Com- | Com- | Com- | Com- | Com- | Com- | Salt additive | | | | | electrode |
| | pound | pound | pound | pound | pound | pound | pound | LiD | LiP | | Additive A | | active |
| Embodiment | 1 | 2 | 3 | 7 | 13 | 18 | 20 | FOB | O₂F₂ | NaPF₆ | FEC | PS | material |
| Embodiment | 1 | / | / | 2 | / | / | / | / | / | / | / | / | Graphite |
| 1 | | | | | | | | | | | | | |
| Embodiment | 0.2 | / | / | 2 | / | / | / | / | / | / | / | / | Graphite |
| 2 | | | | | | | | | | | | | |
| Embodiment | 0.5 | / | / | 2 | / | / | / | / | / | / | / | / | Graphite |
| 3 | | | | | | | | | | | | | |
| Embodiment | 2 | / | / | 2 | / | / | / | / | / | / | / | / | Graphite |
| 4 | | | | | | | | | | | | | |
| Embodiment | / | 1 | / | 2 | / | / | / | / | / | / | / | / | Graphite |
| 5 | | | | | | | | | | | | | |
| Embodiment | / | / | 1 | 2 | / | / | / | / | / | / | / | / | Graphite |
| 6 | | | | | | | | | | | | | |
| Embodiment | 1 | / | / | 0.5 | / | / | / | / | / | / | / | / | Graphite |
| 7 | | | | | | | | | | | | | |
| Embodiment | 1 | / | / | 1 | / | / | / | / | / | / | / | / | Graphite |
| 8 | | | | | | | | | | | | | |
| Embodiment | 1 | / | / | 4 | / | / | / | / | / | / | / | / | Graphite |
| 9 | | | | | | | | | | | | | |
| Embodiment | 1 | / | / | 6 | / | / | / | / | / | / | / | / | Graphite |
| 10 | | | | | | | | | | | | | |
| Embodiment | 1 | / | / | 8 | / | / | / | / | / | / | / | / | Graphite |
| 11 | | | | | | | | | | | | | |
| Embodiment | 1 | / | / | / | 2 | / | / | / | / | / | / | / | Graphite |
| 12 | | | | | | | | | | | | | |
| Embodiment | 1 | / | / | / | / | 2 | / | / | / | / | / | / | Graphite |
| 13 | | | | | | | | | | | | | |
| Embodiment | 1 | / | / | / | / | / | 2 | / | / | / | / | / | Graphite |
| 14 | | | | | | | | | | | | | |
| Embodiment | 1 | / | / | 1 | / | 1 | / | / | / | / | / | / | Graphite |
| 15 | | | | | | | | | | | | | |
| Embodiment | 1 | / | / | 2 | / | / | / | 0.5 | / | / | / | / | Graphite |
| 16 | | | | | | | | | | | | | |
| Embodiment | 1 | / | / | 2 | / | / | / | / | 0.2 | / | / | / | Graphite |
| 17 | | | | | | | | | | | | | |
| Embodiment | 1 | / | / | 2 | / | / | / | / | 0.5 | / | / | / | Graphite |
| 18 | | | | | | | | | | | | | |
| Embodiment | 1 | / | / | 2 | / | / | / | / | / | 0.1 | / | / | Graphite |
| 19 | | | | | | | | | | | | | |
| Embodiment | 1 | / | / | 2 | / | / | / | / | / | / | 3 | / | Graphite |
| 20 | | | | | | | | | | | | | |
| Embodiment | 1 | / | / | 2 | / | / | / | / | / | / | / | 2 | Graphite |
| 21 | | | | | | | | | | | | | |
| Embodiment | 1 | / | / | 2 | / | / | / | / | / | / | 3 | 2 | Graphite |
| 22 | | | | | | | | | | | | | |
| Embodiment | 1 | / | / | 2 | / | / | / | 0.5 | / | / | 3 | 2 | Graphite |
| 23 | | | | | | | | | | | | | |
| Embodiment | 1 | / | / | 2 | / | / | / | 0.5 | / | / | 3 | 0.9 | Graphite |
| 24 | | | | | | | | | | | | | |
| 9 | | | | | | | | | | | | | |
| Embodiment | 1 | / | / | 2 | / | / | / | / | / | / | / | / | Graphite |
| 25 | | | | | | | | | | | | | + |
| | | | | | | | | | | | | | silicon |
| Embodiment | 1 | / | / | 2 | / | / | / | / | 0.49 | / | 2.5 | 1.4 | Graphite |
| 26 | | | | | | | | | | | | | |
| Embodiment | 1 | / | / | 2 | / | / | / | / | 0.5 | / | 3 | 2 | Graphite |
| 27 | | | | | | | | | | | | | |
| Embodiment | 1.5 | / | / | 1.5 | / | / | / | / | 0.7 | / | 2 | 1.5 | Graphite |
| 28 | | | | | | | | | | | | | |
| Embodiment | 1 | / | / | 2 | / | / | / | / | 0.5 | / | 3 | 2 | Graphite |
| 29 | | | | | | | | | | | | | |
| Comparative | 1 | / | / | / | / | / | / | / | / | / | / | / | Graphite |
| Example 1 | | | | | | | | | | | | | |
| Comparative | / | / | / | 2 | / | / | / | / | / | / | / | / | Graphite |
| Example 2 | | | | | | | | | | | | | |
| Comparative | 1 | / | / | / | / | / | / | / | / | / | / | / | Graphite |
| Example 3 | | | | | | | | | | | | | + |
| | | | | | | | | | | | | | silicon |
| Comparative | / | / | / | 2 | / | / | / | / | / | / | / | / | Graphite |
| Example 4 | | | | | | | | | | | | | + |
| | | | | | | | | | | | | | silicon |

“/” indicates that the substance has not been added.

### 2. Cycle Performance Test of a Lithium-Ion Battery

### (1) 45° C. Intermittent Cycle Test

Charge to 4.45V with 0.5 C constant current at 45° C., and then charge to 0.05 C with a constant voltage; lay aside for 20 h at 45° C.; then discharge to 3.0V at 0.5 C constant current; repeat for 100 cycles, and record the capacity retention ratio of the battery.

N(th) cycle capacity retention ratio of the battery=N(th) cycle discharge capacity of the battery/initial discharge capacity of the battery×100%

### (2) High Temperature Resistance Safety Test of a Battery

Charge the lithium-ion secondary battery to a voltage of 4.45V with 0.5 C constant current at 25° C., and then charge to a current of 0.05 C with 4.45V constant voltage;

Put the battery in the oven, heat at 2° C./min from the room temperature, until the battery is burning, monitor the furnace temperature and the surface temperature of the battery, and record the failure temperature of the battery.
Test 5 batteries in each embodiment, and take the average of the test results.

### (3) Energy Density of a Lithium-Ion Battery

Test of battery size: Take three batteries from Embodiment 1 and Embodiment 22 respectively, charge to 3.9V with 0.5 C constant current at 25° C., and then charge to 0.05 C under a constant voltage; measure the battery thickness, width and length using a microcalliper;

Charge to 4.45V with 0.5 C constant current at 25° C., and then charge to 0.025 C under a constant voltage; lay aside for 5 minutes; discharge to 3.0V at 0.1 C constant current; record the discharge energy of the lithium-ion battery;

Energy density (Wh/L)=discharge energy (Wh)/(battery thickness in mm×battery width in mm×battery length in mm×10⁻⁶)

A. The electrolyte and lithium-ion battery in Embodiments 1˜29 and Comparative Examples 1˜4 are prepared according to the preceding method. The 45° C. intermittent cycle capacity retention ratio and thermal failure temperature of the lithium-ion battery are tested, and the test results are as shown in Table 2.

TABLE 2
Performance Test Results of A Lithium-ion Battery

| | | | | | | Thermal |
|---|---|---|---|---|---|---|
| | 45° C. intermittent cycle | | | | | failure |
| | capacity retention ratio (%) | | | | | temper- |
| | 20 | 40 | 60 | 80 | 100 | ature |
| Embodiment | times | times | times | times | times | (° C.) |
| Embodiment 1 | 93.56 | 88.79 | 82.63 | 77.54 | 72.27 | 158.8 |
| Embodiment 2 | 92.74 | 87.62 | 80.23 | 75.62 | 69.42 | 157.2 |
| Embodiment 3 | 93.17 | 88.24 | 81.75 | 76.43 | 71.50 | 158.2 |
| Embodiment 4 | 93.08 | 87.85 | 81.42 | 75.90 | 69.62 | 159.1 |
| Embodiment 5 | 93.19 | 88.23 | 82.30 | 76.63 | 71.78 | 158.2 |
| Embodiment 6 | 92.79 | 87.66 | 82.05 | 76.20 | 70.57 | 157.7 |
| Embodiment 7 | 92.62 | 87.33 | 80.64 | 75.76 | 68.43 | 156.3 |
| Embodiment 8 | 93.19 | 88.35 | 82.32 | 76.15 | 69.91 | 157.4 |
| Embodiment 9 | 93.63 | 88.88 | 82.94 | 78.13 | 73.23 | 160.7 |
| Embodiment 10 | 93.05 | 87.82 | 81.51 | 76.52 | 70.58 | 162.2 |
| Embodiment 11 | 92.59 | 87.18 | 79.84 | 74.33 | 67.58 | 163.7 |
| Embodiment 12 | 93.48 | 88.52 | 82.48 | 77.21 | 72.05 | 158.4 |
| Embodiment 13 | 93.31 | 88.27 | 82.15 | 76.60 | 70.76 | 157.9 |
| Embodiment 14 | 92.40 | 88.36 | 82.33 | 77.07 | 71.44 | 158.2 |
| Embodiment 15 | 93.34 | 88.65 | 82.43 | 76.85 | 71.04 | 158.6 |
| Embodiment 16 | 93.64 | 89.06 | 82.78 | 77.67 | 72.49 | 158.5 |
| Embodiment 17 | 93.59 | 88.89 | 82.76 | 77.63 | 72.46 | 158.2 |
| Embodiment 18 | 93.67 | 89.13 | 82.94 | 77.93 | 72.68 | 158.4 |
| Embodiment 19 | 93.58 | 88.82 | 82.71 | 77.63 | 72.36 | 158.2 |
| Embodiment 20 | 93.92 | 89.22 | 83.13 | 78.21 | 72.80 | 158.6 |
| Embodiment 21 | 93.73 | 89.04 | 82.96 | 77.85 | 72.46 | 159.6 |
| Embodiment 22 | 94.10 | 89.49 | 83.35 | 78.64 | 73.32 | 160.3 |
| Embodiment 23 | 94.19 | 89.66 | 83.60 | 78.98 | 73.84 | 160.6 |
| Embodiment 24 | 93.79 | 87.66 | 82.60 | 78.58 | 73.32 | 159.4 |
| Embodiment 25 | 92.52 | 86.93 | 79.69 | 74.24 | 65.62 | 156.4 |
| Embodiment 26 | 93.54 | 90.13 | 83.94 | 78.93 | 73.68 | 161.4 |
| Embodiment 27 | 95.01 | 91.47 | 84.50 | 79.57 | 74.34 | 161.5 |
| Embodiment 28 | 92.84 | 90.43 | 84.12 | 78.23 | 72.98 | 160.9 |
| Embodiment 29 | 94.73 | 90.98 | 84.66 | 78.93 | 74.21 | 161.2 |
| Comparative | 92.21 | 85.01 | 76.67 | 64.09 | Battery | 148.5 |
| Example 1 | | | | | expansion | |
| Comparative | 92.39 | 86.20 | 79.63 | 71.09 | 60.93 | 153.7 |
| Example 2 | | | | | | |
| Comparative | 91.76 | 83.28 | 73.27 | 58.67 | Battery | 147.6 |
| Example 3 | | | | | expansion | |
| Comparative | 92.13 | 84.54 | 74.55 | 63.35 | Battery | 152.2 |
| Example 4 | | | | | expansion | |

It can be seen from the result comparison between Embodiment 1 and Comparative Examples 1 and 2, and between Embodiment 25 and Comparative Examples 3 and 4 that, the intermittent cycle performance and high temperature resistant safety performance of the lithium-ion battery can be significantly improved by adding the compound represented by Formula I (e.g., compound 1) and compound represented by Formula III (e.g., compound 7) in the electrolyte.

It can be seen from the test results of Embodiments 1˜4 and Comparative Example 1 that, the capacity retention ratio and high temperature resistant safety performance of the lithium-ion battery at high temperature are significantly improved by adding an appropriate amount of the compound represented by Formula III (e.g., compound 7) and about 0.1%˜about 5% compound represented by Formula I (e.g., compound 1) in the electrolyte; when the mass fraction of the compound represented by Formula I in the electrolyte is about 0.2% to about 1%, the effect is particularly ideal.

It can be seen from the test results of Embodiments 1 and 5˜6 that, similar technical effects can be obtained by adding the compound represented by Formula I in each example (e.g., compounds 1, 2 and 3) and the compound represented by Formula III (e.g., compound 7) in the electrolyte.

It can be seen from the test results of Embodiments 1 and 7˜11 and Comparative Example 2 that, the capacity retention ratio and high temperature resistant safety performance of the lithium-ion battery at high temperature are significantly improved by adding an appropriate amount of the compound represented by Formula I (e.g., compound 1) and about 0.1% to about 10% compound represented by Formula III (e.g., compound 7) in the electrolyte; when the mass fraction of the compound represented by Formula IIII in the electrolyte is about 0.5% to about 6%, the effect is particularly ideal.

It can be seen from the test results of Embodiments 1 and 12˜15 that, similar technical effects can be obtained by adding the compound represented by Formula III (e.g., compound 7), compound represented by Formula II (e.g., compound 13), compound represented by Formula IV (e.g., compound 18) or compound represented by Formula V (e.g., compound 20) or combination thereof (e.g., compound 1) in the electrolyte.

It can be seen from the test results of Embodiments 1 and 16˜19 that, the electrolyte added with the compounds represented by Formula I (e.g., compound 1) and Formula III (e.g., compound 7) is further added with an appropriate amount of a salt additive (e.g., at least one of LiDFOB, LiPO₂F₂ or NaPF₆) to further improve the capacity retention ratio and high temperature resistant safety performance of the lithium-ion battery at high temperature.

It can be seen from the test results of Embodiments 1 and 20˜22 that, the electrolyte added with the compounds represented by Formula I (e.g., compound 1) and Formula III (e.g., compound 7) is further added with an appropriate amount of an additive A (e.g., at least one of FEC or PS) to further improve the capacity retention ratio and high temperature resistant safety performance of the lithium-ion battery at high temperature.

It can be seen from the test results of Embodiments 16 and 23 that, the electrolyte added with the compounds represented by Formula I (e.g., compound 1) and Formula III (e.g., compound 7) and an salt additive (e.g., LiDFOB) is further added with an appropriate amount of an additive A (e.g., at least one of FEC or PS) to further improve the capacity retention ratio and high temperature resistant safety performance of the lithium-ion battery at high temperature.

B. The electrolyte and lithium-ion battery in Embodiments 1 and 25 are prepared according to the preceding method. The energy density, 45° C. intermittent cycle capacity retention ratio and thermal failure temperature of the lithium-ion battery are tested, and the test results are as shown in Tables 3˜4.

TABLE 3
Energy Density of A Battery at Different Negative Electrodes

| | | Discharge | Battery | Battery | Battery | Energy |
|---|---|---|---|---|---|---|
| Embod- | Battery | energy | thickness | width | length | density |
| iment | No. | Wh | mm | mm | mm | Wh/L |
| Embod- | 1# | 8.435 | 3.426 | 38.972 | 95.321 | 662.76 |
| iment | 2# | 8.397 | 3.397 | 39.023 | 95.331 | 664.47 |
| 1 | 3# | 8.413 | 3.413 | 39.042 | 95.292 | 662.56 |
| | Average | 8.415 | 3.412 | 39.012 | 95.315 | 663.26 |
| Embod- | 1# | 8.325 | 3.224 | 38.637 | 95.285 | 695.00 |
| iment | 2# | 8.336 | 3.235 | 38.581 | 95.326 | 690.91 |
| 25 | 3# | 8.341 | 3.227 | 38.626 | 95.327 | 691.50 |
| | Average | 8.334 | 3.229 | 38.615 | 95.313 | 692.47 |

TABLE 4
Intermittent Cycle Performance and Thermal Failure Temperature
of A Lithium-ion Battery at Different Negative Electrodes

| | | | | | | Thermal |
|---|---|---|---|---|---|---|
| | 45° C. intermittent cycle | | | | | failure |
| | capacity retention ratio (%) | | | | | temper- |
| | 20 | 40 | 60 | 80 | 100 | ature |
| Embodiment | times | times | times | times | times | (° C.) |
| Embodiment 1 | 93.56 | 88.79 | 82.63 | 77.54 | 72.27 | 158.8 |
| Embodiment 25 | 92.52 | 86.93 | 79.69 | 74.24 | 65.62 | 156.4 |

In Embodiment 25, a negative electrode containing graphite and silicon oxide is used, while in Embodiment 1, a graphite negative electrode is used, and the positive electrode materials of both are the same. The capacity of graphite negative electrode in gram is far lower than that of silicon oxide. Therefore, the loading capacity of Embodiment 25 (graphite and silicon oxide negative electrode) is lower than that of Embodiment 1 (graphite negative electrode). The volume of the battery obtained in Embodiment 25 is smaller, and the energy density is higher than that in Embodiment 1.

Based on the test results of Embodiment 1 and Embodiment 25, use of the electrolyte of the invention in the lithium-ion battery containing graphite negative electrode and the lithium-ion battery containing silicon oxide negative electrode can significantly improve the capacity retention ratio and the high temperature resistant safety performance at high temperature, and the improvement effect for the lithium-ion battery containing graphite negative electrode is particularly remarkable.

The test results of Embodiments 26˜29 show that, the specific separator can maintain good capacity retention ratio and improve the thermal failure of the battery.

To sum up, the electrolyte provided by the invention can form a stable protective layer on the surface of the positive or negative electrode material, so as to ensure the stable charge and discharge of the lithium-ion battery at a high voltage of ≥4.45V. The lithium-ion secondary battery provided by the invention can run properly at high energy density and charge cut-off voltage of ≥4.45V, and has excellent high temperature intermittent cycle capacity retention ratio and high temperature resistant safety performance upon circulation.

The above is only a few embodiments of the invention, and does not limit the invention in any form. Although the invention is disclosed as above in preferred embodiments, it is not used to limit the invention. Any person skilled in the art makes some changes or modifications by using the technical contents disclosed above without departing from the scope of the technical solution of the invention, which are equivalent to the equivalent implementation cases, and belong to the scope of the technical solution.

The reference to “some embodiments”, “partial embodiments”, “one embodiment”, “another example”, “example”, “specific example” or “partial example” throughout the Description means that at least one embodiment or example in the application contains the specific features, structures, materials or characteristics described in the embodiment or example. Therefore, the descriptions in various places throughout the Description, for example, “in some embodiments”, “in embodiments”, “in one embodiment”, “in another example”, “in an example”, “in a specific example” or “an example”, do not necessarily refer to the same embodiment or example in the application. Moreover, the specific features, structures, materials or characteristics herein may be combined in one or more embodiments or examples in any suitable manner. Although the illustrative embodiments have been demonstrated and described, those skilled in the art should understand that the preceding embodiments cannot be interpreted to limit the application, and can be changed, substituted and modified without departing from the spirit, principle and scope of the application.

What is claimed is:

1. An electrolyte, comprising:
a compound represented by Formula I; and
at least one compound represented by Formula II, Formula III, Formula IV or Formula V;
wherein, the compounds represented by Formula I, Formula II, Formula III, Formula IV and Formula V respectively are 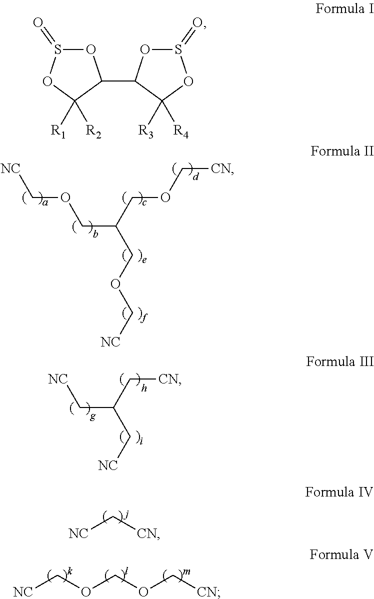
wherein, R₁, R₂, R₃ and R₄ are each independently selected from hydrogen, halogen, substituted or unsubstituted C₁-C₇ alkyl, wherein the substituted group is halogen or cyano group; and
a, d, f, h, j, k, l and m are each independently selected from the integers 1 to 5, and b, c, e, h, g and i are each independently selected from the integers 0 to 5.

2. The electrolyte according to claim 1, wherein
the compound represented by Formula I comprises at least one of the following compounds:

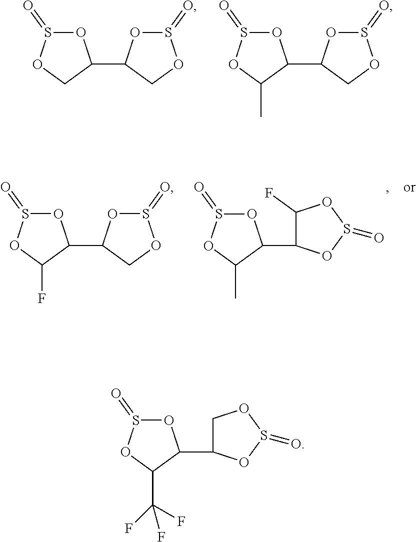

3. The electrolyte according to claim 1, wherein
the compound represented by Formula II comprises at least one of the following compounds: 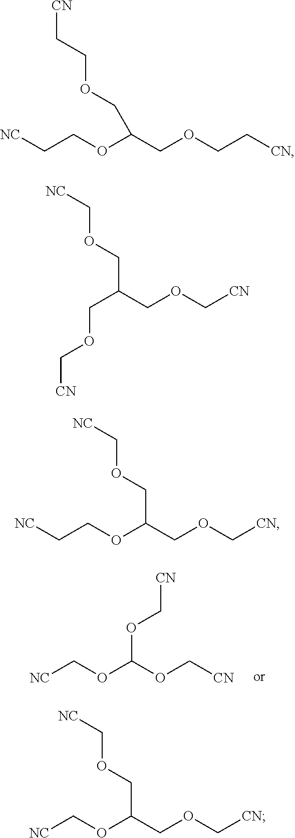
the compound represented by Formula III comprises at least one of the following compounds: 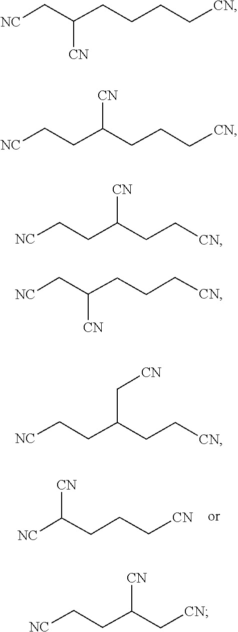
the compound represented by Formula IV comprises at least one of the following compound: 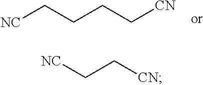
the compound represented by Formula V comprises the following compound:

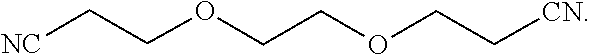 [SMILES: N#CCCOCCOCCC#N]

4. The electrolyte according to claim 1, wherein an amount of the compound represented by Formula I accounts for 0.01% to 5% of the electrolyte by mass; a total amount of the compound represented by Formula II, the compound represented by Formula III, the compound represented by Formula IV and the compound represented by Formula V accounts for 0.01% to 10% of the electrolyte by mass.

5. The electrolyte according to claim 1, further comprising a salt additive, wherein the salt additive comprises at least one of lithium difluoro(oxalato)borate, lithium bis(oxalato)borate, lithium tetrafluoroborate, lithium difluorophosphate, lithium tetrafluorophosphate, lithium tetrafluoro(oxalato)phosphate, lithium difluorobis(oxalato)phosphate, sodium bis(fluorosulfonyl)imide, sodium bis(trifluoromethanesulfonyl)imide, sodium hexafluorophosphate, potassium bis(fluorosulfonyl)imide, potassium bis(trifluoromethanesulfonyl)imide or potassium hexafluorophosphate; an amount of the salt additive accounts for 0.001% to 2% of the electrolyte by mass.

6. The electrolyte according to claim 1, wherein the electrolyte further comprises an additive A, and the additive A comprises at least one of fluoroethylene carbonate, vinylene carbonate, or 1,3-propane sultone; an amount of the additive A accounts for 2% to 9% of the electrolyte by mass.

7. An electrochemical device, comprising a positive electrode, a negative electrode, a separator and an electrolyte, wherein the electrolyte, comprising:
a compound represented by Formula I; and
at least one compound represented by Formula II, Formula III, Formula IV or Formula V;
wherein, the compounds represented by Formula I, Formula II, Formula III, Formula IV and Formula V respectively are 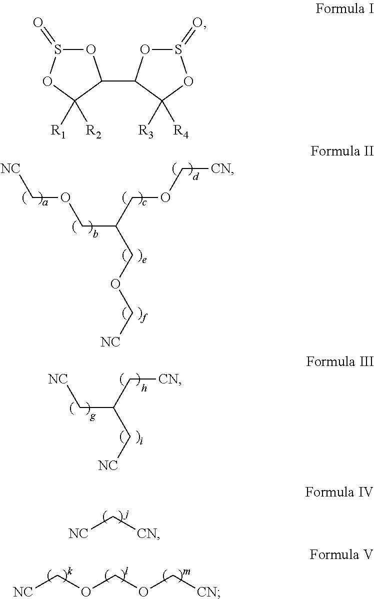
wherein, R₁, R₂, R₃ and R₄ are each independently selected from hydrogen, halogen, substituted or unsubstituted C₁-C₇ alkyl, wherein the substituted group is halogen or cyano group; and
a, d, f, h, j, k, 1 and m are each independently selected from the integers 1 to 5, and b, c, e, h, g and i are each independently selected from the integers 0 to 5.

8. The electrochemical device according to claim 7, wherein
the compound represented by Formula I comprises at least one of the following compounds:

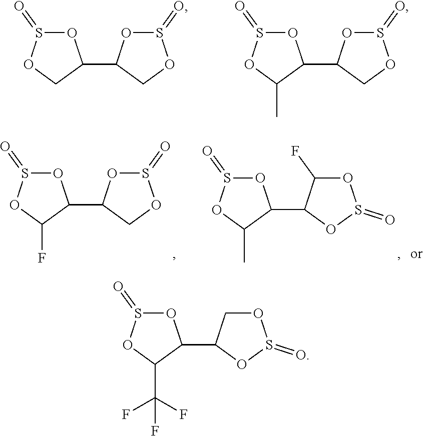

9. The electrochemical device according to claim 7, wherein
the compound represented by Formula II comprises at least one of the following compounds: 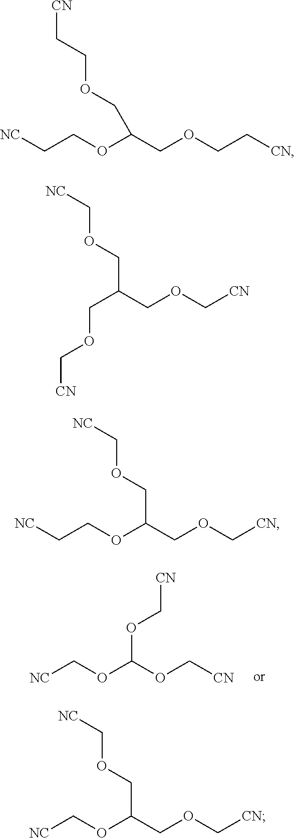
the compound represented by Formula III comprises at least one of the following compounds: 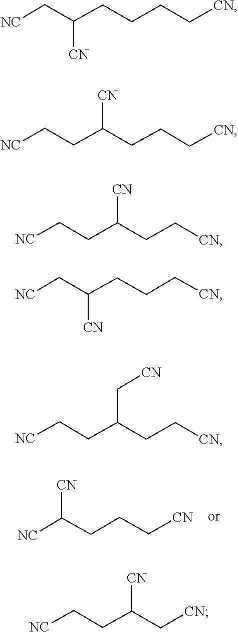
the compound represented by Formula IV comprises at least one of the following compound: 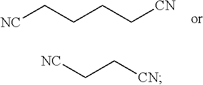
the compound represented by Formula V comprises the following compound:

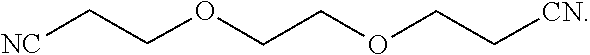 [SMILES: N#CCCOCCOCCC#N]

10. The electrochemical device according to claim 7, wherein an amount of the compound represented by Formula I accounts for 0.01% to 5% of the electrolyte by mass; a total amount of the compound represented by Formula II, the compound represented by Formula III, the compound represented by Formula IV and the compound represented by Formula V accounts for 0.01% to 10% of the electrolyte by mass.

11. The electrochemical device according to claim 7, wherein the electrolyte further comprises a salt additive, and the salt additive comprises at least one of lithium difluoro(oxalato)borate, lithium bis(oxalato)borate, lithium tetrafluoroborate, lithium difluorophosphate, lithium tetrafluorophosphate, lithium tetrafluoro(oxalato)phosphate, lithium difluorobis(oxalato)phosphate, sodium bis(fluorosulfonyl)imide, sodium bis(trifluoromethanesulfonyl)imide, sodium hexafluorophosphate, potassium bis(fluorosulfonyl)imide, potassium bis(trifluoromethanesulfonyl)imide or potassium hexafluorophosphate; an amount of the salt additive accounts for 0.001% to 2% of the electrolyte by mass.

12. The electrochemical device according to claim 7, wherein the electrolyte further comprises an additive A, and the additive A comprises at least one of fluoroethylene carbonate, vinylene carbonate, or 1,3-propane sultone; an amount of the additive A accounts for 2% to 9% of the electrolyte by mass.

13. The electrochemical device according to claim 7, wherein the separator contains a polyolefin layer, and a protective layer which is provided on the polyolefin layer; the protective layer contains at least one of boehmite, Al₂O₃, ZnO, SiO₂, TiO₂ or ZrO₂.

14. The electrochemical device according to claim 13, wherein a thickness of the protective layer is about 0.1 μm to 3 μm.

15. The electrochemical device according to claim 13, wherein the protective layer further contains a polymer, and the polymer comprises at least one of homopolymers and copolymers of tetrafluoroethylene, vinylidene fluoride, hexafluoropropylene, perfluoroalkyl vinyl ether, ethylene, trifluorochloroethylene, propylene, acrylic acid, methacrylic acid, itaconic acid, ethyl acrylate, butyl acrylate, acrylonitrile, methacrylonitrile.

16. The electrochemical device according to claim 13, wherein a ratio of the thickness of the polyolefin layer to the thickness of the protective layer is 1:1 to 20:1.

17. The electrochemical device according to claim 7, wherein the negative electrode contains a negative electrode active material, and the negative electrode active material contains a silicon-containing material and graphite; a weight ratio of the silicon-containing material to the graphite is 5:95 to 50:50.

18. An electronic device, comprising the electrochemical device according to claim 7.
